(19) United States
(12) Patent Application Publication
(10) Pub. No.: US 2015/0114471 A1
(43) Pub. Date: Apr. 30, 2015

(54) Valve Lock

(71) Applicant: Tim Draper, Huntington Beach, CA (US)

(72) Inventor: Tim Draper, Huntington Beach, CA (US)

(21) Appl. No.: 14/515,008

(22) Filed: Oct. 15, 2014

Related U.S. Application Data
(60) Provisional application No. 61/895,736, filed on Oct. 25, 2013.

(51) Int. Cl. F16K 35/10; F16K 3/00; F16K 35/06

(52) U.S. Cl. CPC F16K 35/10; F16K 35/06; F16K 3/00
USPC 137/1; 137/385

(57) ABSTRACT

An improvement for a valve of a type having a stem assembly, a rigid bonnet, and a valve base comprised of a lock cavity formed in the bonnet and adapted to receive a lock mechanism therein, the lock mechanism including a locking pin that is positionable between a locked position and an unlocked position. At least one notch or aperture is formed in the stem assembly and is adapted to receive the locking pin of the lock mechanism when in the locked position. In one embodiment, a bonnet sleeve projects away from the lock cavity and is adapted to receive a locking clasp used with auxiliary padlocks. In another embodiment, the improvement is added to an existing valve as a retrofit product by replacing or modifying the bonnet and stem assembly. In another embodiment, the improvement is built into the valve during manufacturing and delivered as a complete solution.

### RELATED APPLICATIONS

This application is a Non-Provisional utility application which claims priority from provisional application 61/895,736 filed Oct. 25, 2013, which is hereby incorporated herein by reference in its entirety.

### FIELD

This invention relates to valves that can be locked in at least one position.

### BACKGROUND

Manual fluid valves used in industry can generally be set to either a fully open or a fully closed state. The proper operation of a system may depend upon specific valves being in one or the other of those states. A specific set of cases of concern involves maintenance. Often, particular valves must be in a closed state when conducting repairs or maintenance on machinery. There can be a danger to the workers conducting the repairs or maintenance if someone mistakenly opens a valve that has been temporarily closed under these conditions. A person at a valve may not be able to see the workers who could be injured by his actions. Even in cases where workers might not be at risk there may be a risk of damage to equipment if valves are opened or closed contrary to the current operating mode.

Accordingly, it is common practice to set a valve in a desired position and somehow secure it in that position. One common method is to use a chain to secure the valve, the chain being locked to the valve or a valve wheel that controls the valve with a padlock and/or clasp lock that accepts one or more padlocks. However, such a system is cumbersome to use and often the chain is improperly applied to the valve or valve wheel such that the valve may still be at least partially actuated, either through loose chain application, equipment vibration, or tampering. Therefore, there is a need for a reliable locking device for industrial valves.

### SUMMARY

An industrial valve can have an integrated tubular push-in lock embedded in the valve housing adjacent to the stem or rod that controls the valve gate's position. With an aperture, notch, or other female engagement point on the stem aligned with a pin of the lock, the stem can be prevented from moving. With appropriate location of the notch or aperture, the lock can be used to retain the valve in an open state, a closed state, or a state in between. Some embodiments of this can be by a retrofit or an existing valve. Both gate valves and butterfly valves are shown in drawings but the principles of these teaching can be applied to other valve types including ball, plug, and quarter turn valves.

### DESCRIPTION OF THE DRAWINGS

FIG. 1 is a perspective view of an industrial valve with a first embodiment valve lock illustrated with the lock mechanism in an unlocked position;

FIG. 2 is an exploded, perspective view of the apparatus of FIG. 1;

FIG. 3A is a cross-sectional diagram of the apparatus of FIG. 1 along the line 3-3, illustrated with the lock mechanism in the locked position and with the valve in a closed position;

FIG. 3B is a cross-sectional diagram from the view of FIG. 3A, illustrated with so the lock mechanism in the unlocked position and with the valve between an open and the closed position;

FIG. 3C is a cross-sectional diagram from the view of FIG. 3A, illustrated with the lock mechanism in the locked position and with the valve in the open position;

FIG. 4 is a perspective view of an industrial valve with an alternative version lock adapted to receive a clasp lock;

FIG. 5 is a cross-sectional drawing of the apparatus of FIG. 4 in the view and in the state of FIG. 3C;

FIG. 6 shows an alternate stem with holes rather than notches;

FIG. 7 shows an alternate stem with multiple small holes replacing one larger hole;

FIG. 8 is a perspective view of a second embodiment based upon a locking butterfly valve.

### DETAILED DESCRIPTION

Illustrative embodiments of the invention are described below. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number, respectively. Additionally, the words “herein,” “above,” “below” and words of similar import, when used in this application, shall refer to this application as a whole and not to any particular portions of this application. When the claims use the word or in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

### First Embodiment

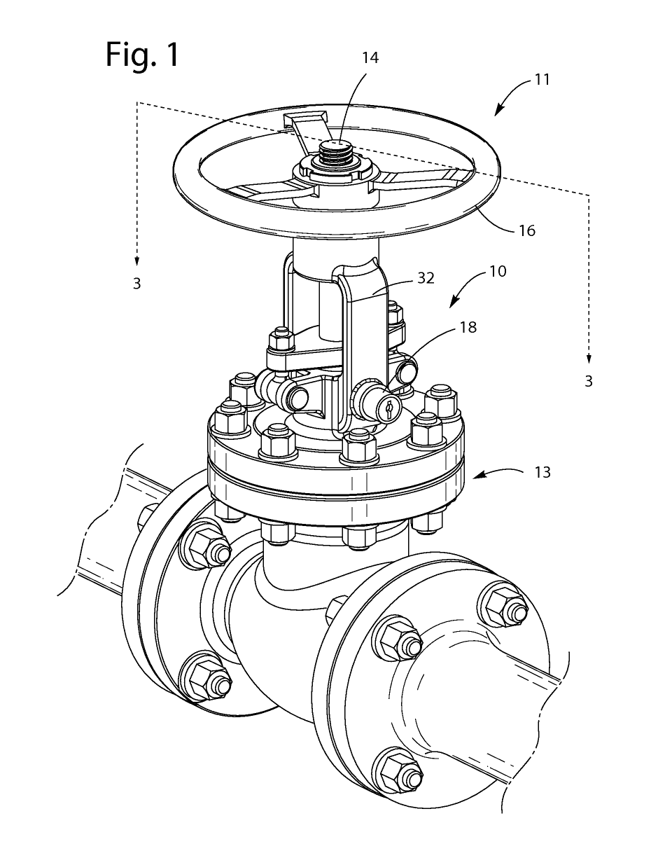

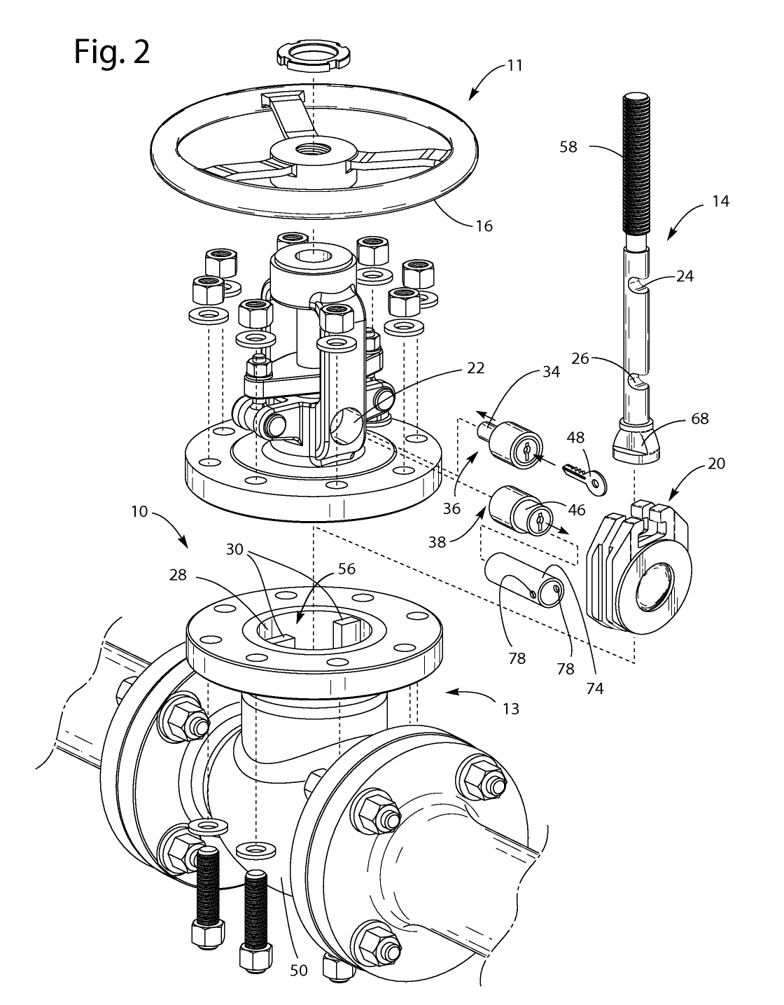

FIGS. 1 and 2 illustrate an improvement 10 for a gate valve 11 of the type having a stem assembly 14, a rigid bonnet 32, and a valve base 13. In this version of the first embodiment, the improvement is added to an existing valve as a retrofit product by replacing or modifying the bonnet 32 and stem assembly. In another version, the improvement is built into the valve during manufacturing and is delivered as a complete solution. The valve shown in these figures has the structure of a bolted bonnet gate valve as described in the American Petroleum Institutes 603 standard. This type of valve has a gate 20 that fits into guides 30 in the primary cavity of the valve 56. The valve gate is raised and lowered by a rod called the stem 14 that is connected to the gate by the stem's horizontal flat surfaces 68 at the distal end.

A lock cavity 22 is formed in the bonnet 32 and is adapted to receive therein a lock mechanism 18. The lock mechanism shown is a tubular “push in” or plunger lock that includes a locking pin 34 adapted to travel between a locked position and an unlocked position. The lock mechanism may be of the type that includes a lock cylinder 46 fixed with the locking pin and that is spring biased towards the unlocked position. Such a lock cylinder is fixed with the lock mechanism in the locked position, but slidably fixed with the lock mechanism when a key 48 unlocks the locking cylinder from the lock mechanism. As such, the lock cylinder and the locking pin may be manually pushed into the locked position against the spring bias and without the key being inserted into the lock cylinder. In this example, the key is required, to unlock the lock cylinder from the lock mechanism and release the lock cylinder and locking pin into the unlocked position. Alternately, the lock mechanism may be of the type where the key must be used to disengage the lock cylinder from the lock mechanism when the lock cylinder is in either the locked position or the unlocked position.

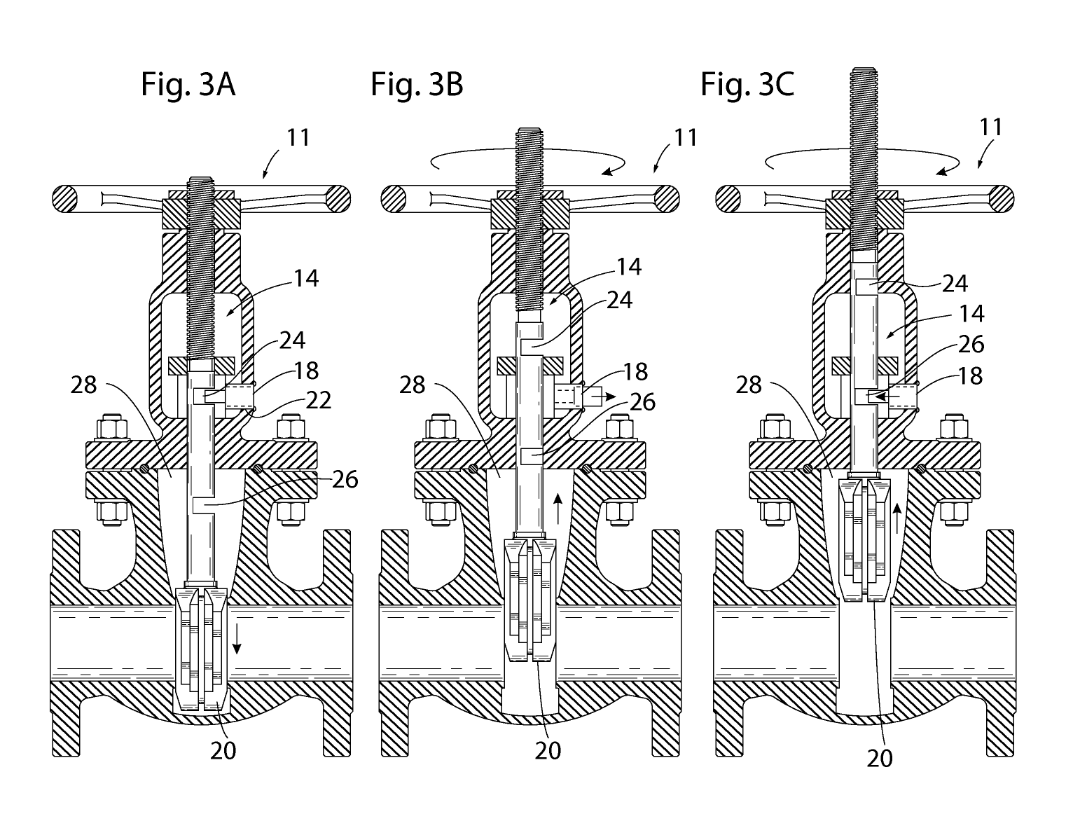

In the example embodiment seen in FIG. 2 a notch 24 is formed in the stem assembly 14. The notch is adapted to receive the locking pin 34 of the lock mechanism 18 when in the locked position. In some versions the notch could be replaced with a through-hole aperture or other mechanical stop. For this to operate as a lock on the state of the valve, the notch must be aligned vertically with the pin with stem and the pin generally at right angles to each other so that the pin enters the notch and prevents vertical motion of the stem. Alternatively, it is possible to have an off-angle pin alignment if the notch is angled appropriately to receive the pin (not shown). Optionally, there is a second notch 26 for securing the valve in the open position, (seen in FIG. 3C). The lock mechanism must be in its unlocked position to allow the stem assembly to move between its open position and closed position (seen in FIG. 3A). The stem assembly is typically threaded 58 and allows movement of a valve gate 20 between the open position and the closed position by rotation a wheel 16, threaded on to the stem assembly. FIG. 3B shows the stem unlocked and transitioning between open and closed.

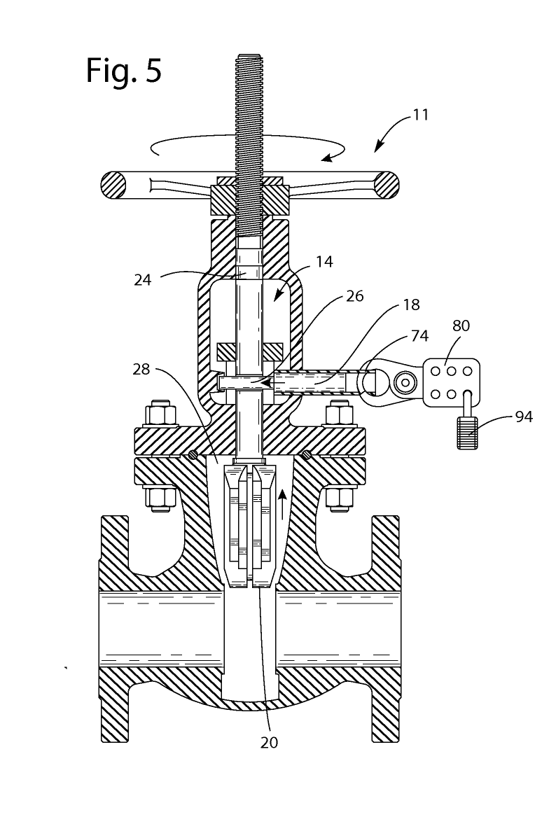

Other types of valves may allow for alternate mechanisms to move the stem up and down, such as solenoid-driven valves (not shown). In any case, when the locking pin 34 engages the notch or aperture 24 of the stem assembly in the locked and closed position, the stem assembly is prevented from up-and-down movement, thereby locking the valve in place. In an embodiment seen in FIG. 5 the bonnet to includes a pin notch 47 opposite the lock cavity 22 and adapted to receive the distal end of the locking pin 34 when the lock mechanism 18 is in the locked position. This design option can provide a greater strength and may allow the use of smaller pins and apertures. In the specific type of valve illustrated the stem does not rotate. In other valve types, like a butterfly valve, restricting stem rotation can be a way of locking a valve in position.

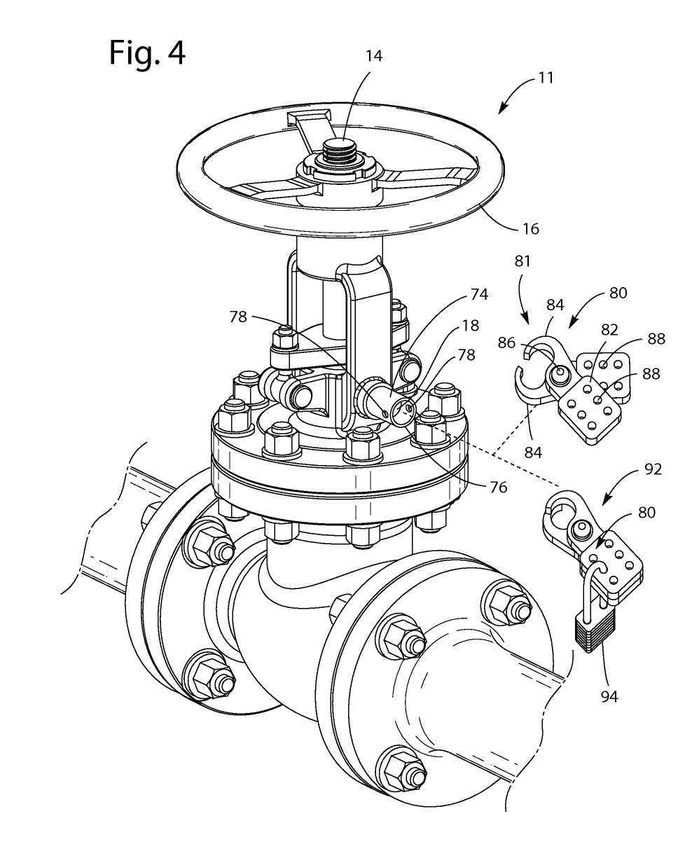

In an alternate version, the bonnet 32 is modified to include a bonnet sleeve 74 that is not a keyed lock (seen in FIG. 4) projecting away from the bonnet at the lock cavity 22. Although this sleeve might be thought of as a stop rather than a lock, it is considered a type lock in this document. The end 76 of the bonnet sleeve closest to the user can include a one clasp lock aperture 78 whereby an auxiliary lock 80 may be applied through the clasp lock aperture to inhibit vandalism of the lock mechanism 18 and securing of the stem assembly 14 from unauthorized movement. The auxiliary lock may be a padlock 94, for example. In a variation, a plunger without an integral lock might be used. A clasp lock might be used to secure a plunger either in a retracted position, allowing valve operation, or in a “pushed in” position preventing valve operation.

In another variation, the lock may be a clasp lock 90 of the type having two plates 82 pivotally fixed at a pivot 86, each having a portion of a shackle 84 that overlaps when the plates are pivoted to assume a locked position 92. These are known as multi-hasp lockout clasps. Each plate has multiple lock apertures 88 that allow a padlock 94 to be inserted therethrough for locking the clasp lock into the locked position. When all padlocks are removed, the plates may pivot away from each other so that each portion of the shackle rotates away from the other, allowing the clasp lock to be engaged or disengaged with the at least one clasp lock aperture 78 of the bonnet sleeve 74. In this manner the valve 11 may be locked in the closed position of FIG. 3A, for example, with the lock mechanism 18, and the clasp lock 80 engaged with the bonnet sleeve and locked with the padlock. In order for the valve to be opened both the padlock and the lock mechanism must be unlocked. Additional padlocks may be added to the clasp lock to allow multiple users to lock the valve, each perhaps having different keys or combinations for their padlock.

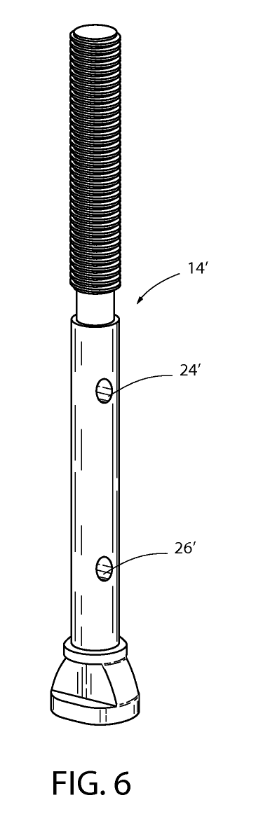

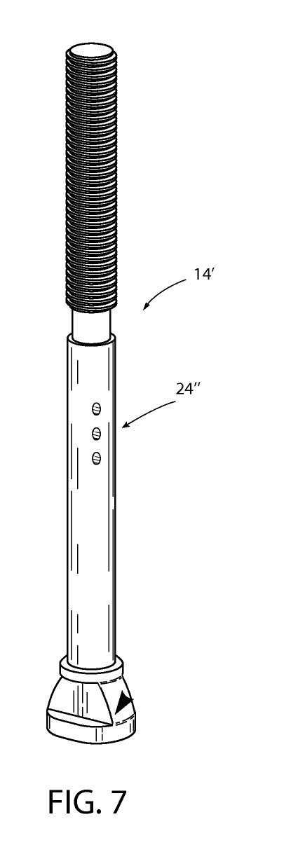

Many variations are possible. FIG. 6 shows an alternate stem with holes 24′ rather than notches. FIG. 7 shows an example of a second variation where multiple small holes 24″ are used in place of a larger single hole or notch. This may reduce the impact of the apertures on the structural integrity of the stem and could be aligned as shown, or possibly staggered. Of course the pin would be adapted to engage whatever stop structure was implemented in the stem. The notches, apertures, large holes, and smaller holes all provide the function of a stop that a pin in a lock may interact with. Other types of mechanical stops may interact with levers or other components of alternate locks.

### Second Embodiment

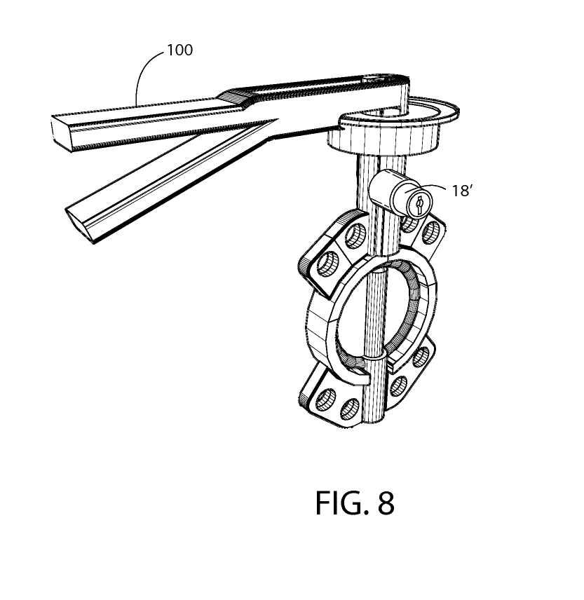

FIG. 8 shows a one-quarter turn butterfly valve adapted to have a push-in tubular lock that interacts with a stop on the stem of the butterfly valve. As a quarter-turn device, the valve has a lever 100 rather than a wheel. The lock's 18′ internal operation is similar to that of the valve of the first embodiment. However, since the motion being restricted in this case is rotational rather than axial, a hole or a vertical notch stop in the stem would be functional to restrain movement.

While some particular forms of lockable valves have been illustrated and described, it will be apparent that various modifications can be made without departing from the spirit and scope of the invention.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above “Detailed Description” section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Changes can be made to the invention in light of the above “Detailed Description.” While the above description details certain embodiments of the invention and describes the best mode contemplated, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

It is claimed:

1. An industrial valve with an integrated lock comprising:
a) a housing having a fluid inlet and fluid outlet, an opening for a stem that controls the state of the valve and a lock body portion;
b) a valve plate within the housing having at least two operationally positional states, the at least two states including open and closed with respect to fluid flow
c) a stem operatively coupled to the valve plate and extending outside the housing through the opening for a rod;
the housing, valve plate, and rod mutually configured such that changing the position of the valve gate between the at least two states is engendered by external manipulation of the rod;
d) a lock within the lock body portion having a pin slideably supported within the lock body along the axis of the pin, the axis being generally at a right angle to the stem; and
where the stem has at least one aperture or one notch, located and oriented to be proximate to the pin and aligned with the axis of the pin when the valve is in at least one of the at least two positional states; the alignment and proximity such that when the pin is slid towards the rod, the pin engages the aperture thereby preventing the motion of the rod that engenders a change of state of the valve.

2. The industrial valve with an integrated lock of claim 1 where the lock pin's slidable motion is restricted by a lock mechanism.

3. The industrial valve with an integrated lock of claim 1 where the valve is a gate valve type.

4. The industrial valve with an integrated lock of claim 1 where the valve is a butterfly valve type.

5. The industrial valve with an integrated lock of claim 1 where the at least one aperture or notch in the stem is aligned with the pin when the gate is in a closed state.

6. The industrial valve of claim 1 where the at least one notch or one aperture comprises a notch.

7. The industrial valve of claim 1 where the at least one notch or one aperture comprises an aperture.

8. The industrial valve of claim 1 where the motion restriction of the stem comprises a restriction on rotation.

9. The industrial valve of claim 1 where the motion restriction of the stem comprises a restriction on translation.

10. An industrial valve comprising an axially, slidably disposed pin supported within a housing portion of the valve with the axis generally at right angles to the stem of the valve, the stem having at least one stop, where the relative locations and alignment of the stem, stop and pin are such as to restrict the motion of the stem that engenders opening the valve when the pin is translated toward the stem.

11. The industrial valve of claim 10 where the translation of the pin from a motion-restricting to a motion-allowing state can be readily, mechanically prevented by external user manipulation.

12. The industrial valve of claim 11 where the mechanical prevention is by a lock.

13. The industrial valve of claim 10 where the valve is a gate valve with a non-rising stem.

14. The industrial valve of claim 10 where the valve is chosen from a gate valve, a butterfly valve, a ball valve, a plug valve, and a quarter turn valve.

15. The industrial valve of claim 12 where the lock is a tubular push-in lock.

16. A method of preventing a valve from being opened comprising:
a) pushing in an external tubular lock that is at generally at right angles to the internal stem;
b) sliding a pin attached to the lock in an axial direction;
c) mechanically engaging a stop structure on the stem with the slid pin;
whereby the motion of the stem is restricted and thereby the valve is prevented from being opened.

16. The method of claim 15 where the stem is prevented from axial movement.

17. The method of claim 16 where the stem is prevented from rotational movement.

18. The method of claim 15 further comprising:
locking the pin in position engaged with a stop on the stem, therefore preventing a valve-opening stem motion in a locked manner.
